(19) United States
(12) Patent Application Publication
(10) Pub. No.: US 2023/0059171 A1
(43) Pub. Date: Feb. 23, 2023

(54) INTELLIGENT PERFORMANCE-BASED REAL ESTATE SOLUTIONS

(71) Applicant: Neyborly, Inc., Berkeley, CA (US)

(72) Inventors: Benjamin Michael Seidl, Santa Cruz, CA (US); Robert Fairclough, JR., San Francisco, CA (US); Russel Andrew Seidl, Oakland, CA (US)

(21) Appl. No.: 17/445,496

(22) Filed: Aug. 19, 2021

(51) Int. Cl. G06Q 50/16; G06K 9/00

(52) U.S. Cl. CPC G06Q 50/163; G06K 9/00671; G06K 9/00785

(57) ABSTRACT

Various embodiments include systems and methods of calculating performance-based rent. Sensor(s) may capture object data associated with objects in an interior and/or exterior environment of a commercial real estate location. Computing device(s) may obtain sales data associated with sales transactions attributable to the commercial real estate location; determine, based at least in part on the object data captured by the sensor(s), object traffic value(s) indicative of an amount of traffic of at least one of the objects; and calculate, based at least in part on performance metric values indicative of actual sales performance and potential sales performance of the commercial real estate location over a particular period of time, a performance-based rent for the commercial real estate location. The performance metric values comprise the sales data and the object traffic value(s), and the performance-based rent is variable over different periods of time with different performance metric values.

### BACKGROUND

Commercial real estate leasing and property management typically relies on several manual or otherwise inefficient practices. For example, one conventional practice is to utilize census data from city traffic studies to gauge street-level activity at a particular location. Such census data may provide outdated, inaccurate, or otherwise limited information for understanding street-level activity. As another example, another conventional practice relates to rent charge and collection, with a fixed rent on a multiple-year lease where rent is collected via check or wire transfer. As yet another example, with respect to touring and access, conventional practice is for a broker to utilize a key to open a space for a potential tenant and to give an in-person tour. Accordingly, there is a need for improved systems and methods of commercial real estate leasing and property management.

### SUMMARY OF EMBODIMENTS

The systems and methods described herein may be employed in various combinations and in embodiments to provide “performance-based real estate” solutions that address various shortcomings of conventional commercial real estate leasing and property management practices. The systems and methods of the present disclosure may enable a property owner (e.g., an owner of a commercial real estate location) to monetize and market their vacant commercial spaces autonomously using a combination of artificial intelligence (AI) data, cameras, and software. Installation of various hardware and software components at a commercial real estate location may enable commercial real estate owners to monetize, automate, and quantify their commercial real estate vacancies in real-time. A mobile application may allow potential tenants to open commercial real estate spaces with their mobile phone and wireless (e.g., Bluetooth®) locks. An owner dashboard may enable commercial real estate owners to quantify and operate their real estate listings autonomously in real-time (including AI traffic data, rent charged/collected, visitor data, entries, etc.). In some cases, the systems and methods of the present disclosure may enable entrepreneurs to open a retail storefront and to pay based on performance of the retail space. In contrast to the conventional practice of utilizing census data for understanding street-level activity, the present disclosure may enable searchable real-time traffic data (e.g., cars, bikes, pedestrians) in front of a specific storefront/property. In contrast to conventional practices related to rent charge and collection, the present disclosure may enable variable rent based on street-level data, sales, and occupancy with rent collected automatically, e.g., via an automated clearing house (ACH) transfer. In contrast to conventional practices related to touring and access, the present disclosure may enable a potential lessee to open a wireless lock via a mobile application that may guide the potential lessee through a tour with video chat on a mobile device.

### BRIEF DESCRIPTION OF THE DRAWINGS

FIG. 1 is a block diagram illustrating various components of a performance-based real estate system, in accordance with some embodiments.

FIGS. 2A to 2C are diagrams illustrating touring and access of a commercial real estate location using the performance-based real estate system of the present disclosure, in accordance with some embodiments.

FIGS. 3A to 3C are diagrams illustrating real-time customer and sales data collection at a commercial real estate location using the performance-based real estate system of the present disclosure, in accordance with some embodiments.

FIG. 4 is a diagram illustrating real-time pedestrian and vehicle data collection at a commercial real estate location using the performance-based real estate system of the present disclosure, in accordance with some embodiments.

FIG. 5 is a diagram of a merchant interface that provides information regarding available commercial real estate locations that utilize the performance-based real estate system of the present disclosure, in accordance with some embodiments.

FIG. 6 is a diagram of a merchant interface that provides information regarding an application for a particular available commercial real estate location that utilizes the performance-based real estate system of the present disclosure, in accordance with some embodiments.

FIG. 7 is a diagram of a performance interface that provides real-time performance information for a particular commercial real estate location that utilizes the performance-based real estate system of the present disclosure, in accordance with some embodiments.

FIG. 8 is a flowchart that illustrates an example process of calculating a performance-based rent for a particular commercial real estate location that utilizes the performance-based real estate system of the present disclosure, in accordance with some embodiments.

FIG. 9 is a flowchart that illustrates an example process of enabling a potential merchant to access and tour a commercial real estate location that utilizes the performance-based real estate system of the present disclosure, in accordance with some embodiments.

FIG. 10 is a flowchart that illustrates an example process of real-time collection of customer and sales data at a commercial real estate location using the performance-based real estate system of the present disclosure, in accordance with some embodiments.

FIG. 11 is a flowchart that illustrates an example process of real-time collection of pedestrian and vehicle data at a commercial real estate location using the performance-based real estate system of the present disclosure, in accordance with some embodiments.

FIG. 12 is a block diagram illustrating an example computer system that may be used to implement one or more portions of a performance-based real estate system, according to some embodiments.

While embodiments are described herein by way of example for several embodiments and illustrative drawings, those skilled in the art will recognize that embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION OF EMBODIMENTS

The systems and methods of the present disclosure relate to a technology system to automate commercial real estate leasing and rent collection. The system of the present disclosure includes a set of hardware and software solutions that may be referred to herein as “performance real estate” solutions which may enable a commercial real estate owner to monetize and market their vacant commercial space autonomously in real-time using artificial intelligence (AI) data, cameras, and software. The performance real estate solutions of the present disclosure provide searchable real-time traffic data (cars, bikes, pedestrians) at a specific storefront/property. With the performance real estate solutions of the present disclosure, merchants may be charged variable rent based on street-level data, sales, and occupancy, with rent collected from a merchant automatically via ACH transfer and paid to an owner of the commercial real estate location automatically via ACH transfer (per a specific rental agreement). With the performance real estate solutions of the present disclosure, a mobile application may be utilized to open a wireless lock and to guide a potential merchant through a location via a self-guided tour with optional video chat (aka “telebrokerage”). Thus, the performance real estate solutions of the present disclosure provides numerous advantages over conventional real estate industry operations.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, and components have not been described in detail so as not to unnecessarily obscure aspects of the embodiments.

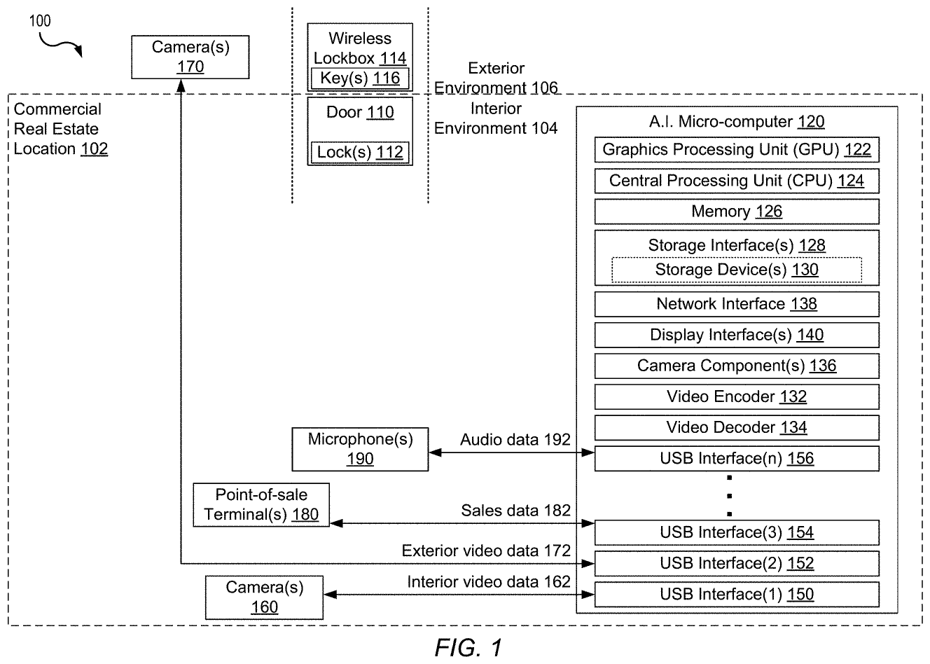

Referring to FIG. 1, a diagram 100 illustrates various components of a performance-based real estate system, according to some embodiments. As illustrated and further described herein, the various components depicted in FIG. 1 may enable detection and real-time updates of customers, sales, pedestrians, and vehicles associated with a commercial real estate location 102 that utilizes the performance-based real estate system of the present disclosure.

FIG. 1 illustrates, via dashed lines, an interior environment 104 and an exterior environment 106 of the commercial real estate location 102. For ease of illustration purposes, the dashed lines depicted in FIG. 1 show in a simplified format that one or more physical structures of the commercial real estate location 102 may define a boundary between the interior environment 104 and the exterior environment 106. It will be appreciated that the various elements depicted in FIG. 1 are not to scale and are for illustrative purposes only.

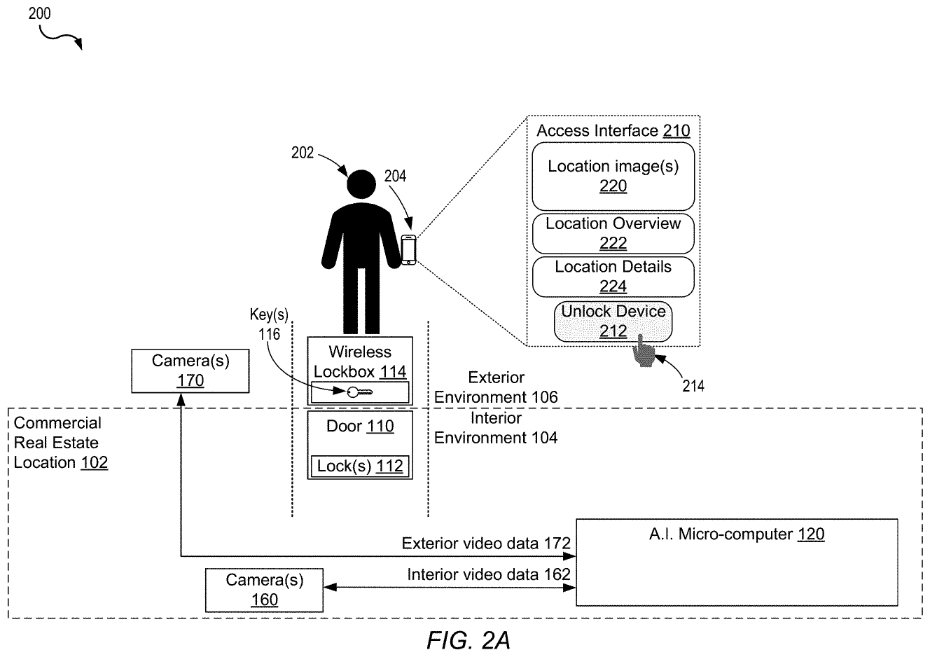

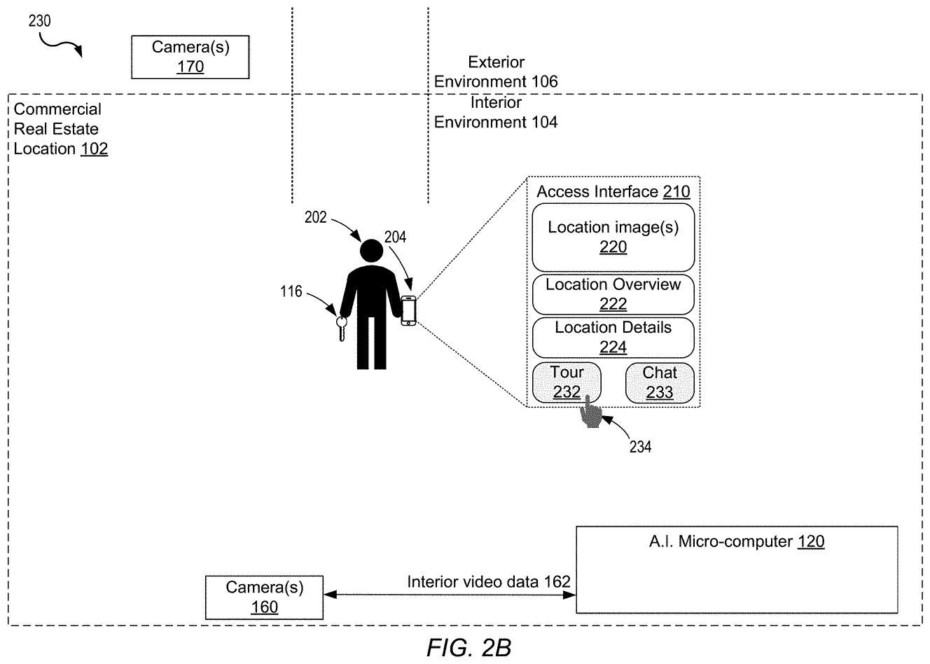

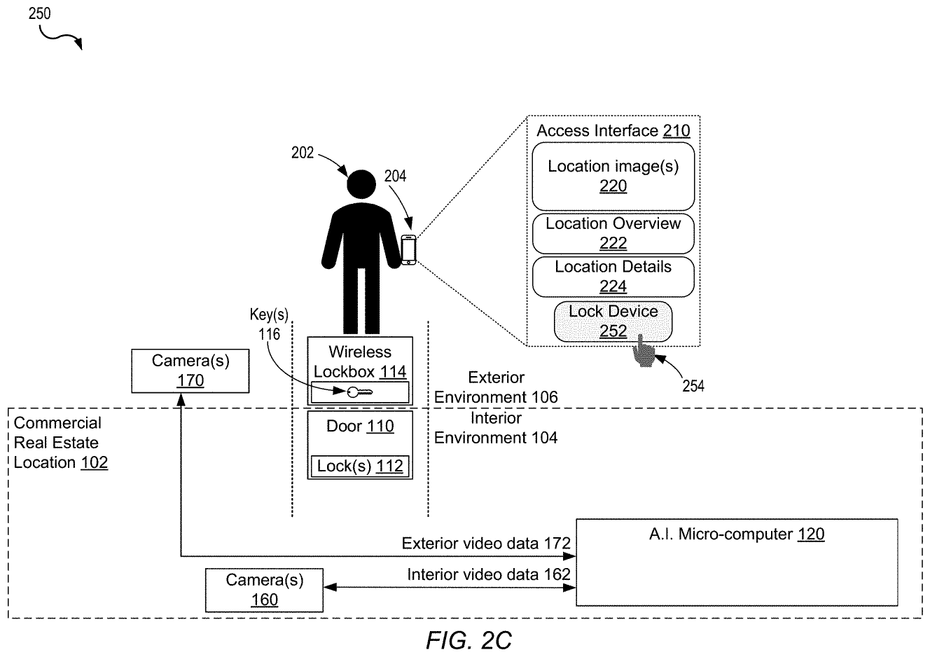

In FIG. 1, the commercial real estate location includes a door 110 (between the exterior environment 106 and the interior environment 104) having one or more locks 112. FIG. 1 further illustrates that a wireless lockbox 114 may house one or more keys 116 that may open the lock(s) 112 of the door 110, according to some embodiments. As illustrated and further described herein with respect to FIGS. 2A to 2C, the wireless lockbox 114 may enable potential merchants/tenants to access and tour the commercial real estate location 102, thereby providing advantages to both commercial real estate owners and potential merchants/tenants by enabling secure access and touring without the involvement of a commercial real estate broker. In alternative embodiments, the door 110 itself may include an integrated wireless lock controller (not shown) that may provide the ability to open the lock(s) 112 without the key(s) 116 or the wireless lockbox 114 depicted in FIG. 1.

FIG. 1 illustrates that one or more computing resources may be located at the commercial real estate location 102. In the particular embodiment depicted in FIG. 1, the computing resource(s) include at least an artificial intelligence (AI) micro-computer 120 that includes: a graphics processing unit (GPU) 122; a central processing unit (CPU) 124; memory 126; and one or more storage interfaces 128 configured to receive one or more storage devices 130 (e.g., a microSD card, among other alternatives). The AI micro-computer 120 may include logic to perform computer vision operations. The logic to perform such computer vision operations may be stored at the memory 126 of the AI micro-computer 120, at the storage device(s) 130, or a combination thereof. As described herein, the computer vision operations may include determining one or more object traffic values, and the determination of such object traffic values may include performing object detection, objection classification, and/or object tracking, according to some embodiments.

The AI micro-computer 120 also includes: a video encoder 132; a video decoder 134; one or more camera components 136; a network interface 138; and one or more display interfaces 140. In the particular embodiment depicted in FIG. 1, the AI micro-computer 120 has multiple interfaces (e.g., Universal Serial Bus (USB) interfaces, among other possibilities), including: a first USB interface 150; a second USB interface 152; a third USB interface 154; through an nth USB interface 156.

FIG. 1 further illustrates that one or more sensors may be utilized for capturing object data associated with objects in the interior environment 104 of the commercial real estate location 102, in the exterior environment 106 of the commercial real estate location 102, or a combination thereof. In some embodiments, various types of sensors may be selected for the commercial real estate location 102 that can be utilized for object recognition. Illustrative, non-limiting examples of such sensors may include cameras, lidar sensors, radar sensors, ultrasonic sensors, time of flight (TOF) sensors, among other alternatives. In some cases, a combination of data from different types of sensors may be fused in order to perform object recognition at the commercial real estate location 102.

FIG. 1 illustrates that the sensor(s) may include one or more interior cameras 160 located on the interior environment 104 of the commercial real estate location 102. The interior camera(s) 160 may be configured to capture interior video data 162 and to communicate the interior video data 162 to the AI micro-computer 120 (e.g., via the first USB interface 150 in the example depicted in FIG. 1).

FIG. 1 further illustrates that the sensor(s) may include one or more exterior cameras 170 located in the exterior environment 106 of the commercial real estate location 102. The exterior camera(s) 170 may be configured to capture exterior video data 172 and to communicate the exterior video data 172 to the AI micro-computer 120 (e.g., via the second USB interface 152 in the example depicted in FIG. 1).

One or more point-of-sale (POS) terminals 180 that may be configured to capture sales data 182 and to communicate the sales data 182 to the AI micro-computer 120 (e.g., via the third USB interface 154 in the example depicted in FIG. 1).

As described further herein, the AI micro-computer 120 may include logic to calculate a performance-based rent for the commercial real estate location 102. The logic to perform such performance-based rent calculations may be stored at the memory 126 of the AI micro-computer 120, at the storage device(s) 130, or a combination thereof. As described herein, as part of the performance-based rent calculations, the AI micro-computer 120 may be configured to obtain the sales data 182 associated with sales transactions attributable to the commercial real estate location 102. As part of the performance-based rent calculations, the AI micro-computer 120 may be configured to determine, based at least on object data captured by the one or more sensors (e.g., the interior camera(s) 160, the exterior camera(s) 170, or a combination thereof), object traffic values indicative of an amount of traffic of at least one object (e.g., pedestrians, customers, vehicles, etc.) as described further herein. As described further herein, as part of the performance-based rent calculations, the AI micro-computer 120 may be configured to calculate a performance-based rent for the commercial real estate location 102 that may be variable over different periods of time with different performance metric values.

FIG. 1 illustrates that, in some embodiments, one or more microphones 190 may also be located on the interior environment 104 of the commercial real estate location 102. The microphone(s) 190 may be configured to capture audio data 192 and to communicate the audio data 192 to the AI micro-computer 120 (e.g., via the nth USB interface 156 in the example depicted in FIG. 1).

Thus, FIG. 1 an example of various components of a performance-based real estate system according to the present disclosure. As illustrated and further described herein, the various components depicted in FIG. 1 may enable access by potential merchants/tenants to the commercial real estate location 102 as well as detection and real-time updates of customers, sales, pedestrians, and vehicles associated with the commercial real estate location 102.

FIGS. 2A to 2C are diagrams illustrating that the performance-based real estate system of the present disclosure enables a potential merchant to access and tour a commercial real estate location, in accordance with some embodiments. In the example depicted in FIG. 2A, a diagram 200 illustrates a first stage of access and touring operations in which a merchant 202 is located in the exterior environment 106 of the commercial real estate location 102, and the wireless lockbox 114 of FIG. 1 provides the ability for a merchant 202 to gain access to the key(s) 116 in order to access and tour the interior environment 104 of the commercial real estate location 102. In the example depicted in FIG. 2B, a diagram 230 illustrates a subsequent stage of the access and touring operations in which the merchant 202 has gained access and is able to tour the interior environment 104 of the commercial real estate location 102. In the example depicted in FIG. 2C, a diagram 250 illustrates a subsequent stage of the access and touring operations in which, after touring the interior environment 104 of the commercial real estate location 102, the potential merchant 202 may exit to the exterior environment 106. FIG. 2C illustrates that the wireless lockbox 114 of FIG. 1 provides the ability for the merchant 202 to return the key(s) 116 to the wireless lockbox 114 and lock the key(s) 116 in the wireless lockbox 114 in order to re-secure the commercial real estate location 102 upon completion of their tour.

In some embodiments, before the potential merchant 202 can be granted access to the commercial real estate location 102, the potential merchant 202 may go through an identity verification process via the mobile device 204. As an illustrative, non-limiting example, the identity verification process may include the potential merchant 202 taking a picture of a legally-valid and acknowledged identification (ID) card (e.g., drivers license, passport, Real ID, etc.) for comparison to a “selfie” image that the potential merchant 202 is requested to take using the mobile device 204. Such an ID verification process may be conducted before the potential merchant 202 is granted access to and/or provided with a tour of the commercial real estate location 102.

Referring to FIG. 2A, the diagram 200 illustrates that the merchant 202 may utilize a mobile device 204 to wirelessly unlock the wireless lockbox 114 in order to access the key(s) 116 to the lock(s) 112 on the door 110 of the commercial real estate location 102. In FIG. 2A, the mobile device 204 displays an access interface 210 that includes a selectable unlock device option 212. FIG. 2A illustrates a particular embodiment in which the mobile device 204 includes a touchscreen and the merchant 202 provides a touchscreen input 214 to select the unlock device option 212 via the access interface 210. It will be appreciated that alternative methods may be utilized to unlock the wireless lockbox 114, such as a voice input from the merchant 202 received via a microphone of the mobile device 204, among other possibilities. Upon selection of the unlock device option 212, the mobile device 204 may generate a first wireless signal (e.g., a first Bluetooth® signal, among other possibilities) to trigger the wireless lockbox 114 to unlock.

In the embodiment depicted in FIG. 2A, the access interface 210 further displays one or more location images 220, a location overview 222, and location details 224 associated with the commercial real estate location 102. FIG. 2A illustrates that, in some cases, the exterior camera(s) 170 may be configured to send image(s) of the merchant 202 to the AI micro-computer 120 as part of the exterior video data 172 (e.g., for security purposes and for documenting information regarding the unlocking of the wireless lockbox 114). FIG. 2A illustrates that, in some cases, the interior camera(s) 160 may be configured to send image(s) of the merchant 202 to the AI micro-computer 120 as part of the interior video data 162 (e.g., for security purposes and for documenting information regarding the unlocking of the wireless lockbox 114).

Thus, FIG. 2A illustrates a first stage of the access and touring operations in which the merchant 202 is located in the exterior environment 106 of the commercial real estate location 102 and, prior to selection of the unlock device option 212 of the access interface 210, the key(s) 116 remain locked in the wireless lockbox 114.

Referring to FIG. 2B, the diagram 230 illustrates a subsequent stage of the access and touring operations in which, after unlocking wireless lockbox 114 to gain access to the key(s) 116 in order to unlock the lock(s) 112 of the door 110, the merchant 202 is able to enter and tour the interior environment 104 of the commercial real estate location 102.

In the embodiment depicted in FIG. 2B, the access interface 210 displayed at the mobile device 204 includes a selectable tour option 232. FIG. 2B illustrates a particular embodiment in which the merchant 202 provides a second touchscreen input 234 to select the tour option 232 via the access interface 210 in order to initiate a tour of the interior environment 104 of the commercial real estate location 102. It will be appreciated that alternative methods may be utilized to initiate the tour, such as a voice input from the merchant 202 received via a microphone of the mobile device 204, among other possibilities. In some embodiments, the tour may include audio and/or video output via the mobile device 204 that may provide additional information to the potential merchant 202 regarding the commercial real estate location 102, such as a self-guided tour through the interior environment 104 of the commercial real estate location 102. In the embodiment depicted in FIG. 2B, the access interface 210 displayed at the mobile device 204 includes a selectable chat option 233 to initiate a telebrokerage session with a telebroker. While not shown in FIG. 2B, in some embodiments, selection of the selectable chat option 233 by the potential merchant 202 may initiate a video chat service with a cloud-based broker. The cloud-based broker may utilize a computing device at another location to provide information to the potential merchant 202 without being physically present at the commercial real estate location 102 at the same time as the potential merchant 202.

FIG. 2B illustrates that, in some cases, the interior camera(s) 160 may be configured to send image(s) of the merchant 202 to the AI micro-computer 120 as part of the interior video data 162 (e.g., for security purposes and for documenting information regarding individuals that tour the interior environment 104 of the commercial real estate location 102).

Thus, FIG. 2B illustrates a second stage of the access and touring operations in which the potential merchant 202 has gained access to the interior environment 104 of the commercial real estate location 102 and is able to tour the interior environment 104 (e.g., via a self-guided tour, in some cases).

Referring to FIG. 2C, the diagram 250 illustrates a subsequent stage of the access and touring operations in which, after touring the interior environment 104 of the commercial real estate location 102, the potential merchant 202 may exit to the exterior environment 106.

In the embodiment depicted in FIG. 2C, the potential merchant 202 has returned the key(s) 116 to the wireless lockbox 114 after utilizing the key(s) 116 to lock the door 110 of the commercial real estate location 102. FIG. 2C further illustrates that the access interface 210 displayed at the mobile device 204 includes a selectable lock device option 252. FIG. 2C illustrates a particular embodiment in which the merchant 202 provides a third touchscreen input 254 to select the lock device option 252 via the access interface 210. Upon selection of the lock device option 252, the mobile device 204 may generate a second wireless signal (e.g., a second Bluetooth® signal, among other possibilities) to trigger the wireless lockbox 114 to lock.

FIG. 2C illustrates that, in some cases, the exterior camera(s) 170 may be configured to send image(s) of the merchant 202 to the AI micro-computer 120 as part of the exterior video data 172 (e.g., for security purposes and for documenting information regarding the locking of the door 110, the return of the key(s) 116, and the locking of the wireless lockbox 114). FIG. 2A illustrates that, in some cases, the interior camera(s) 160 may be configured to send image(s) of the merchant 202 to the AI micro-computer 120 as part of the interior video data 162 (e.g., for security purposes and for documenting information regarding the locking of the door 110, the return of the key(s) 116, and the locking of the wireless lockbox 114).

Thus, FIGS. 2A to 2C illustrate that the performance-based real estate system of the present disclosure enables the potential merchant 202 to access and tour the commercial real estate location 102. By utilizing a combination of the wireless lockbox 114 and the access interface 210, the performance-based real estate system of the present disclosure provides advantages to both commercial real estate owners and potential merchants by enabling secure access and touring without the involvement of a commercial real estate broker.

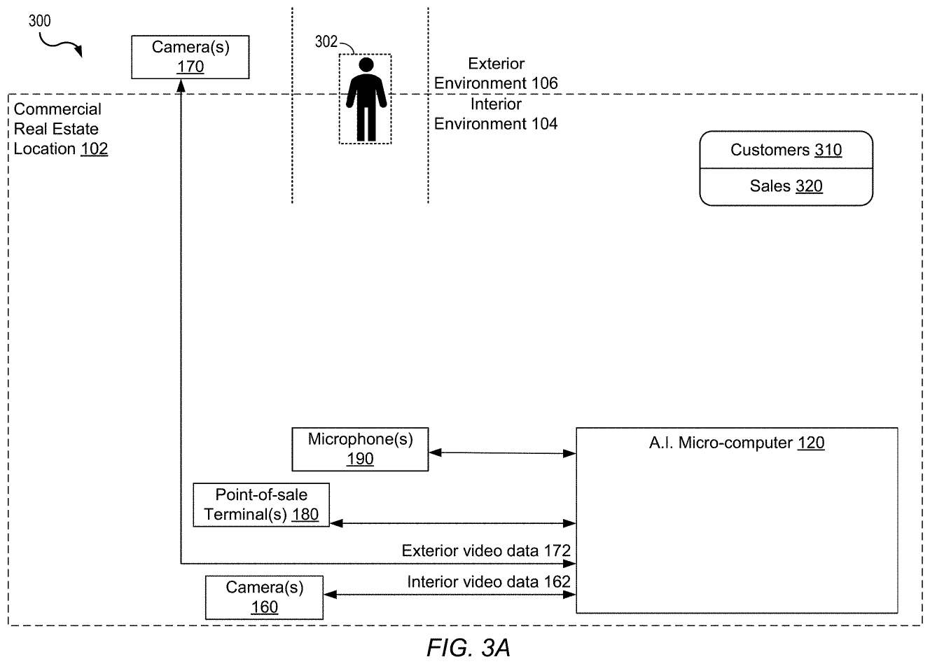

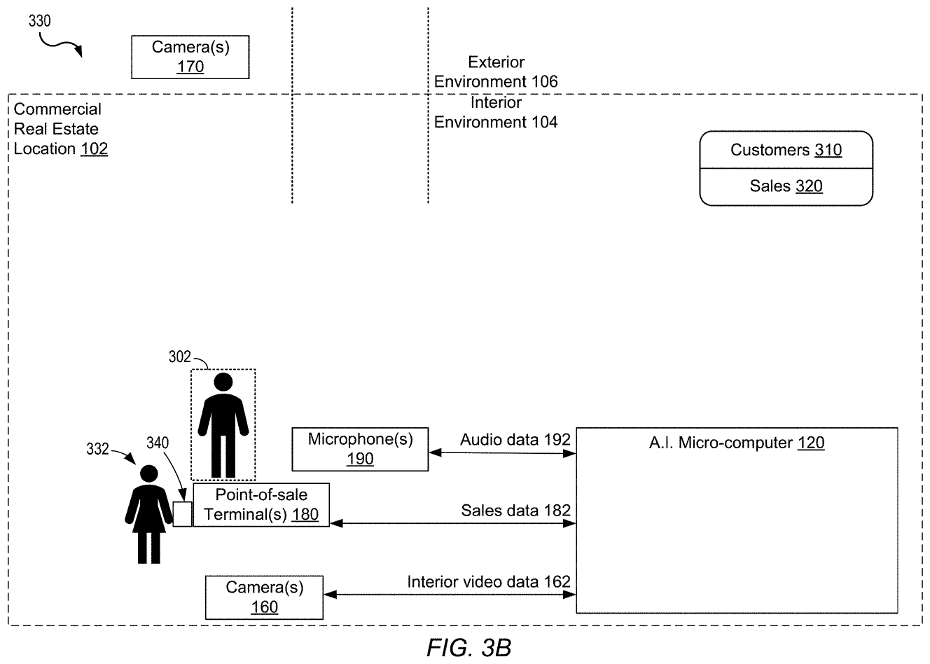

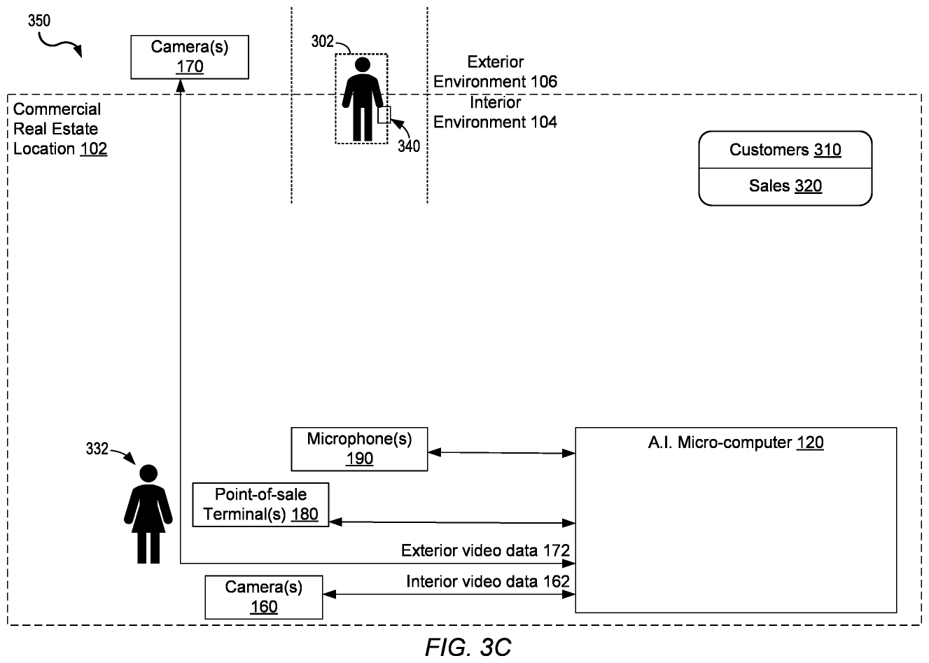

FIGS. 3A to 3C are diagrams illustrating real-time collection of customer and sales data at a commercial real estate location using the performance-based real estate system of the present disclosure, in accordance with some embodiments. In the example depicted in FIG. 3A, a diagram 300 illustrates a first stage of real-time collection of customer and sales data in which a customer 302 enters the interior environment 104 of the commercial real estate location 102. In the example depicted in FIG. 3B, a diagram 330 illustrates a subsequent stage of real-time collection of customer and sales data in which the customer 302 completes a sales transaction at the commercial real estate location 102. In the example depicted in FIG. 3C, a diagram 350 illustrates a subsequent stage of real-time collection of customer and sales data in which the customer 302 returns to the exterior environment 106 of the commercial real estate location 102 after completion of the sales transaction.

Referring to FIG. 3A, the diagram 300 illustrates that the customer 302 has entered the interior environment 104 of the commercial real estate location 102. The AI micro-computer 120 may be configured to detect the entry of the customer 302 based on the interior video data 162 received from the interior camera(s) 160 or based on a combination of the interior video data 162 and the exterior video data 172 received from the exterior camera(s) 170. FIG. 3A illustrates a bounding box around the customer 302, indicative of the AI micro-computer 120 having recognized the customer 302 as a human based on image recognition logic. In some cases, the AI micro-computer 120 may be configured to super-impose the bounding box around the customer 302 in the interior video data 162 and may be configured to store such data in the memory 126 or at the storage device(s) 130 (not shown in FIG. 3A, see FIG. 1). Additionally, FIG. 3A illustrates that the AI micro-computer 120 may maintain real-time customer data 310 and real-time sales data 320, and this data may also be super-imposed on the interior video data 162 in some cases (e.g., for presentation to a merchant via a user interface, not shown).

Referring to FIG. 3B, the diagram 330 illustrates that the customer 302 has proceeded to the point-of-sale (POS) terminal(s) 180, where a retail associate 332 may receive merchandise 340 from the customer 302. FIG. 3B illustrates, via the lack of a bounding box surrounding the retail associate 332, that the AI micro-computer 120 may be configured to recognize that the retail associate 332 is not to be included in the real-time customer data 310. FIG. 3B illustrates that the POS terminal(s) 180 may be configured to send the sales data 182 associated with the merchandise 340 in order to update the real-time sales data 320. FIG. 3B further illustrates that, in some cases, the microphone(s) 190 may be configured to send the audio data 192 to the AI micro-computer 120 (e.g., to be stored in association with the customer 302 and/or the merchandise 340).

In a particular embodiment, the POS terminal(s) 180 may utilize software capable of handling the complexity of the performance real estate solutions of the present disclosure. For example, the POS terminal(s) 180 may utilize POS software that is able to inventory all items being sold at the commercial real estate location 102, to provide customized control/ownership of the sales data 182, and to own/manage the payouts to both merchants and owners directly in real-time. As an illustrative, non-limiting example, if the sale of merchandise 340 corresponds to a $70 sale, a provider of the performance-based real estate solutions may receive a first portion (e.g., 10 percent) and an owner of the commercial real estate location 102 may receive a second portion (e.g., 10 percent), and the POS software automatically send a merchant their share only (i.e., minus the first/second portions, fee(s), and performance-based rent). Additionally, it will be appreciated that when an item is put up for sale at a particular location (e.g., the merchandise 340 at the commercial real estate location 102), the item may also be made available via an online retail marketplace to create an “omnichannel” experience where customers can shop the same item in-store or online. In some cases, selected high-value unique (non-fungible) items may be recorded on a blockchain (e.g., the Ethereum blockchain) so that a record of the transaction and ownership rights are permanently and publicly recorded on the blockchain for use, trade, or ownership verification in virtual worlds (e.g., a “metaverse” environment).

Referring to FIG. 3C, the diagram 300 illustrates that the customer 302 has proceeded from the POS terminal(s) 180 with the merchandise 340 to exit the commercial real estate location 102. The AI micro-computer 120 may be configured to detect the exit of the customer 302 based on the interior video data 162 received from the interior camera(s) 160 or based on a combination of the interior video data 162 and the exterior video data 172 received from the exterior camera(s) 170.

Thus, FIGS. 3A to 3C illustrate that the performance-based real estate system of the present disclosure enables real-time collection of customer and sales data at the commercial real estate location 102.

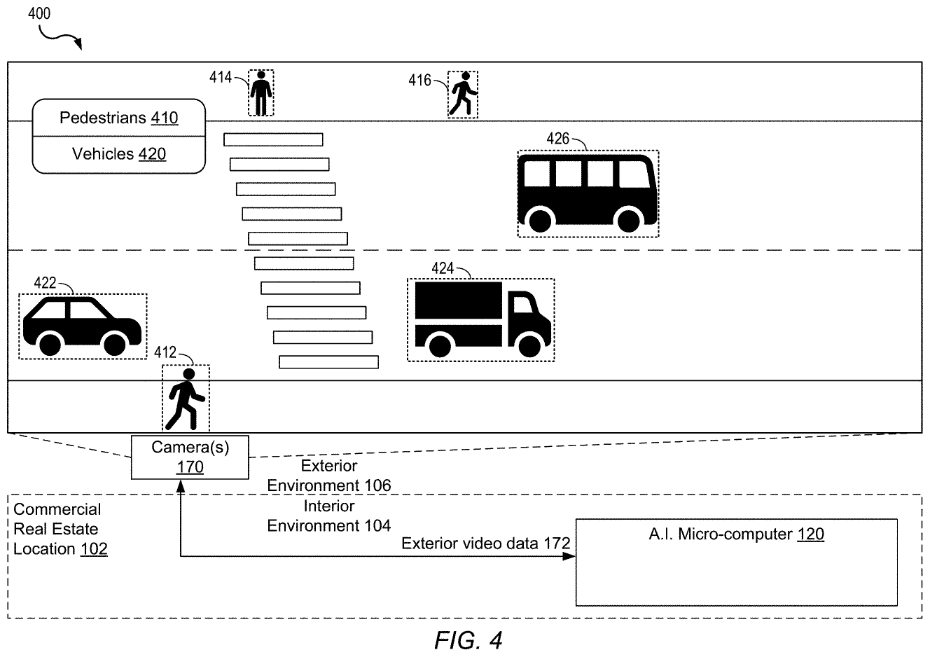

FIG. 4 is a diagram 400 illustrating real-time pedestrian and vehicle data collection at a commercial real estate location using the performance-based real estate system of the present disclosure, in accordance with some embodiments.

FIG. 4 illustrates that the exterior camera(s) 170 of the commercial real estate location 102 may send the exterior video data 172 to the AI micro-computer 120, and the AI micro-computer 120 may be configured to recognize pedestrians and vehicles in the exterior environment 106 using object recognition techniques. FIG. 4 illustrates various bounding boxes, indicative of the AI micro-computer 120 having recognized various pedestrians based on the exterior video data 172 and image recognition logic. FIG. 4 illustrates various bounding boxes, indicative of the AI micro-computer 120 having recognized various vehicles based on the exterior video data 172 and image recognition logic.

In some cases, the AI micro-computer 120 may be configured to super-impose the bounding boxes around the identified pedestrians/vehicles in the exterior video data 172 and may be configured to store such data in the memory 126 or at the storage device(s) 130 (not shown in FIG. 4, see FIG. 1). Additionally, FIG. 4 illustrates that the AI micro-computer 120 may maintain real-time pedestrian data 410 and real-time vehicle data 420, and this data may also be super-imposed on the exterior video data 172 in some cases (e.g., for presentation to a merchant via a user interface, not shown).

In the illustrative, non-limiting example depicted in FIG. 4, bounding boxes are used to indicate that the AI micro-computer 120 has identified a first pedestrian 412, a second pedestrian 414, and a third pedestrian 416. Additionally, bounding boxes are used to indicate that the AI micro-computer 120 has identified a first vehicle 422, a second vehicle 424, and a third vehicle 426. In some cases, the AI micro-computer 120 may utilize image recognition logic to determine that the first vehicle 422 corresponds to a first vehicle type (e.g., a passenger car), that the second vehicle 424 corresponds to a second vehicle type (e.g., a commercial truck), and that the third vehicle 426 corresponds to a third vehicle type (e.g., a bus). In the illustrative, non-limiting example depicted in FIG. 4, the AI micro-computer may update the real-time pedestrian data 410 to increment a count of pedestrians by three based on the three identified pedestrians 412, 414, and 416. Further, in the illustrative, non-limiting example depicted in FIG. 4, the AI micro-computer may update the real-time vehicle data 420 to increment a count of vehicles by three based on the three identified vehicles 422, 424, and 426.

Thus, FIG. 4 illustrates that the performance-based real estate system of the present disclosure may enable real-time pedestrian and vehicle data collection at the commercial real estate location 102.

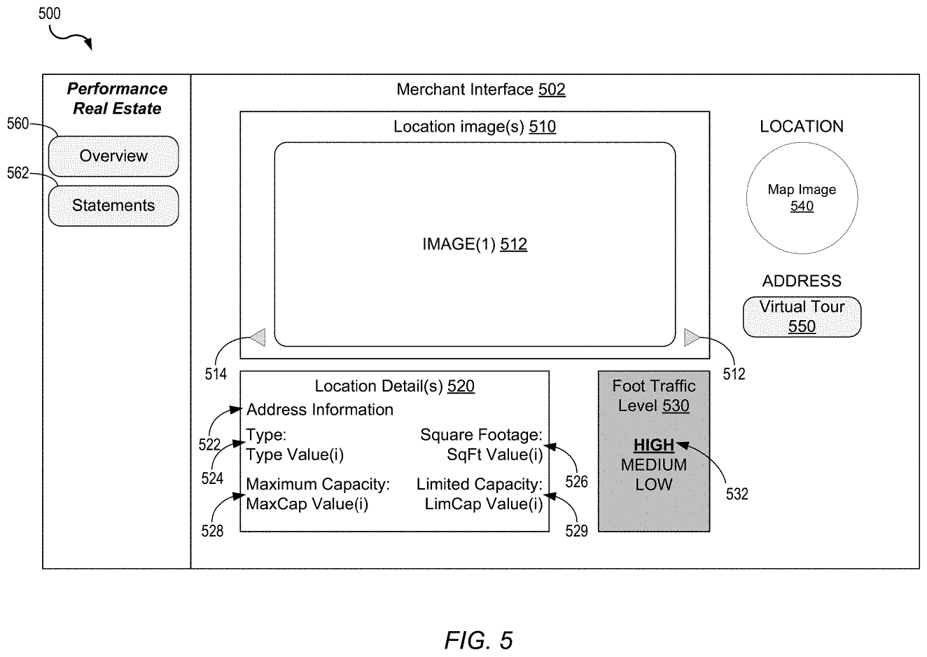

FIG. 5 is a diagram 500 of a merchant interface 502 that provides information regarding available commercial real estate locations that utilize the performance-based real estate system of the present disclosure, in accordance with some embodiments.

The merchant interface 502 of FIG. 5 illustrates that a merchant may browse for available commercial real estate locations to identify a particular space that satisfies their criteria. FIG. 5 illustrates that the merchant interface 502 may display one or more location images 510 associated with a particular available commercial real estate location to assist the merchant with identifying a suitable space. In FIG. 5, a first image 512 may be displayed, and the merchant interface 502 may enable the merchant to scroll between other images (e.g., by selecting a next image icon 512 or by selecting a previous image icon 514). Alternatively, for a device with a touchscreen such as a mobile device (e.g., the mobile device 204 depicted in FIGS. 2A to 2C) the merchant interface 502 may be configured to enable the merchant to swipe left or right to scroll between available images.

The merchant interface 502 of FIG. 5 further illustrates one or more location details 520 associated with a particular location (e.g., the commercial real estate location 102 of FIG. 1), according to some embodiments. In the example depicted in FIG. 5, the location detail(s) 520 include: address information 522; a location type 524; a location area 526 (e.g., square footage); and a maximum capacity 528. In some cases, the location detail(s) 520 may also identify a limited capacity 529 (e.g., in accordance with local, state, or federal health guidelines, as an example), among other possible location detail information.

The merchant interface 502 of FIG. 5 further illustrates that a foot traffic level 530 may be displayed for the particular location (e.g., the commercial real estate location 102 of FIG. 1), according to some embodiments. As previously described herein, such information may be obtained using the exterior camera(s) 170 that provide the exterior video data 172 to the AI micro-computer 120 in order to maintain the real-time count of pedestrians 410 (see e.g., FIG. 4). In the embodiment depicted in FIG. 5, the foot traffic level 530 is identified as a high foot traffic level 532 based on foot traffic level criteria. FIG. 5 illustrates that the foot traffic level 530 may alternatively be characterized as medium or low based on the foot traffic level criteria, in other cases. Such information may be useful to the merchant in evaluating whether a particular location is satisfactory for their merchant standards.

The merchant interface 502 of FIG. 5 further illustrates that a map image 540 may be displayed for the particular location (e.g., the commercial real estate location 102 of FIG. 1), according to some embodiments. Additionally, the merchant interface 502 of FIG. 5 depicts a selectable virtual tour option 550 to enable the merchant to take a virtual tour of the particular location. In some cases, the virtual tour may be similar to the one described previously herein with respect to the self-guided tour available to the merchant 202 in FIG. 2A when visiting the commercial real estate location 102. Alternatively, the selectable option 550 in FIG. 5 may present a different virtual tour that may be more informative or understandable for the merchant when they are not physically present at the particular location.

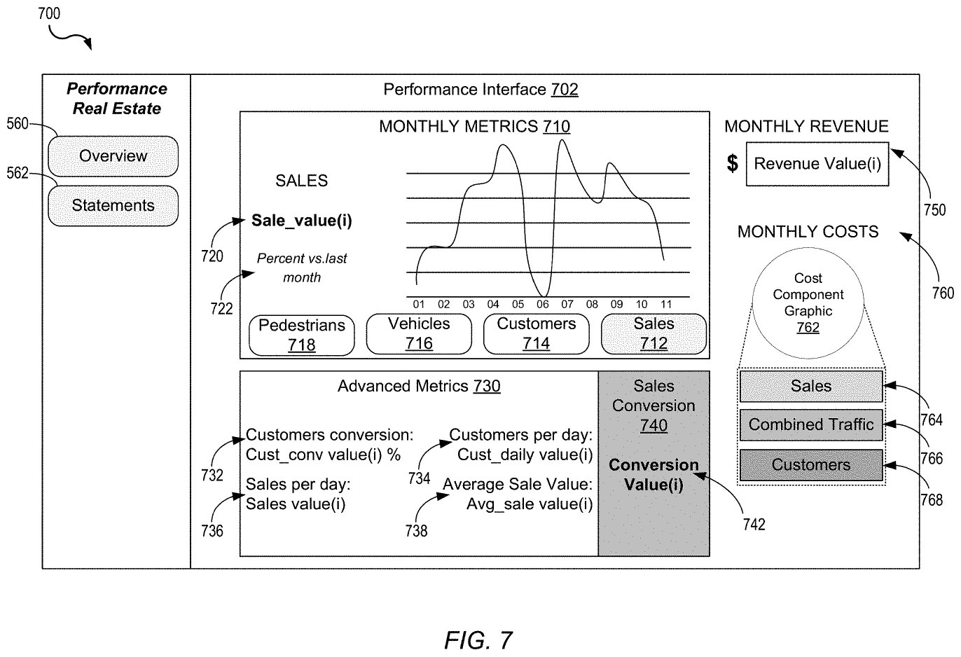

In the particular embodiment depicted in FIG. 5, the merchant interface 502 also displays a selectable overview option 560 and a selectable statements option 562. These selectable options 560, 562 may provide additional information for the merchant once the merchant has identified a particular location, submitted an application, and been approved to utilize the particular location. For example, once the merchant has been accepted and placed in the particular location, the merchant may be able to track location, revenue, and cost metrics over the course of their utilization of the particular location (see e.g., FIG. 7).

Thus, FIG. 5 illustrates that the merchant interface 502 may provide various types of information regarding available commercial real estate locations that utilize the performance-based real estate system of the present disclosure. Such information may be useful to a merchant to identify a particular location that satisfies their merchant standards.

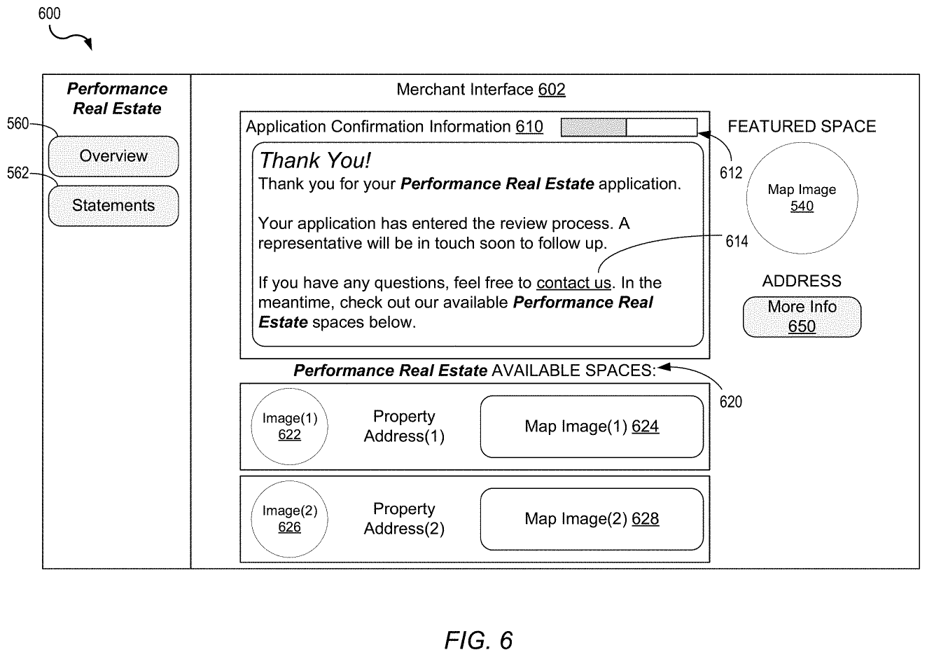

FIG. 6 is a diagram 600 of a merchant interface 602 that provides information regarding an application for a particular available commercial real estate location that utilizes the performance-based real estate system of the present disclosure, in accordance with some embodiments.

The merchant interface 602 of FIG. 6 may be displayed after the merchant has submitted an application for a particular space that satisfies their criteria. At this point, the merchant enters the review process. In the example depicted in FIG. 6, the merchant interface 602 displays application confirmation information 610, which may include an application progress bar 612 and textual information. For example, the textual information may inform the merchant that the application has entered the review process and that a representative may be in touch soon to follow up (e.g., within 48 hours, in one embodiments). Additionally, FIG. 6 illustrates that the textual information may include a hyperlink 614 to enable the merchant to contact a representative with questions, etc.

The merchant interface 602 of FIG. 6 illustrates that, during the review process, the merchant can view other available commercial real estate locations 620 that utilize the performance-based real estate system of the present disclosure. In the example depicted in FIG. 6, information associated with two other available locations is illustrated. Information associated with a first available location (having a first property address) may include a first thumbnail image 622 and a first map image 624. Information associated with a second available location (having a second property address) may include a second thumbnail image 626 and a second map image 628. FIG. 6 illustrates that, after submitting an application, the selectable virtual tour option 550 depicted in FIG. 5 may be replaced with a selectable more information option 650 in the merchant interface 602. In some cases, upon selection of the more information option 650, the merchant may be returned to the merchant interface 502 of FIG. 5 to view the details associated with the particular location that the merchant applied for.

Thus, FIG. 6 illustrates that the merchant interface 602 may inform the merchant that the application has entered the review process. FIG. 6 illustrates an example in which, during the review process, the merchant can view other available commercial real estate locations 620 that utilize the performance-based real estate system of the present disclosure.

FIG. 7 is a diagram 700 of a performance interface 702 that provides real-time performance information for a particular commercial real estate location that utilizes the performance-based real estate system of the present disclosure, in accordance with some embodiments.

In the example depicted in FIG. 7, the performance interface 702 displays various data about utilization of a particular location (e.g., the commercial real estate location 102 of FIG. 1). For example, the performance interface 702 may illustrate monthly metrics 710 regarding sales 712, customers 714, vehicles 716, and pedestrians 720, among other possible metrics. In the embodiment depicted in FIG. 7, the performance interface 702 illustrates an example of the monthly metrics 710 regarding the sales 712 in a graphical format. It will be appreciated that monthly data related to the customers 714, the vehicles 716, or the pedestrians 718 at the particular location may be displayed in a similar graphical format upon selection. With respect to the sales 712, the monthly metrics 710 may include a total sales value 720 as well as a relative sales value 722 (e.g., compared to a previous month). While not shown in FIG. 7, the performance interface 702 may be configured to display a particular sales value for a particular day responsive to a mouse hovering over a particular area of the graphical display (or otherwise identified by a user, such as via a touchscreen interface).

In the example of FIG. 7, the performance interface 702 also displays advanced metrics 730 regarding customers conversion 732, customers per day 734, sales per day 736, average sale value 738, among other possible metrics. In the example of FIG. 7, the performance interface 702 also displays sales conversion 740 which may be represented as a sales conversion value 742 or in some other graphical format.

In the example of FIG. 7, the performance interface 702 also displays monthly revenue 750 (e.g., in a textual or graphical format) and information associated with monthly costs 760. In the embodiment depicted in FIG. 7, the monthly costs 760 may include a cost component graphic 762 (e.g., as a pie chart or similar graphic), which may break down costs based on a sales component 764, a combined traffic component 766, and a customers component 768. Such information may be obtained using data processed by the AI micro-computer 120, as described further herein.

Thus, FIG. 7 illustrates that the performance interface 702 may provide real-time performance information for a particular commercial real estate location that utilizes the performance-based real estate system of the present disclosure. Such information may provide valuable insights for merchant operations.

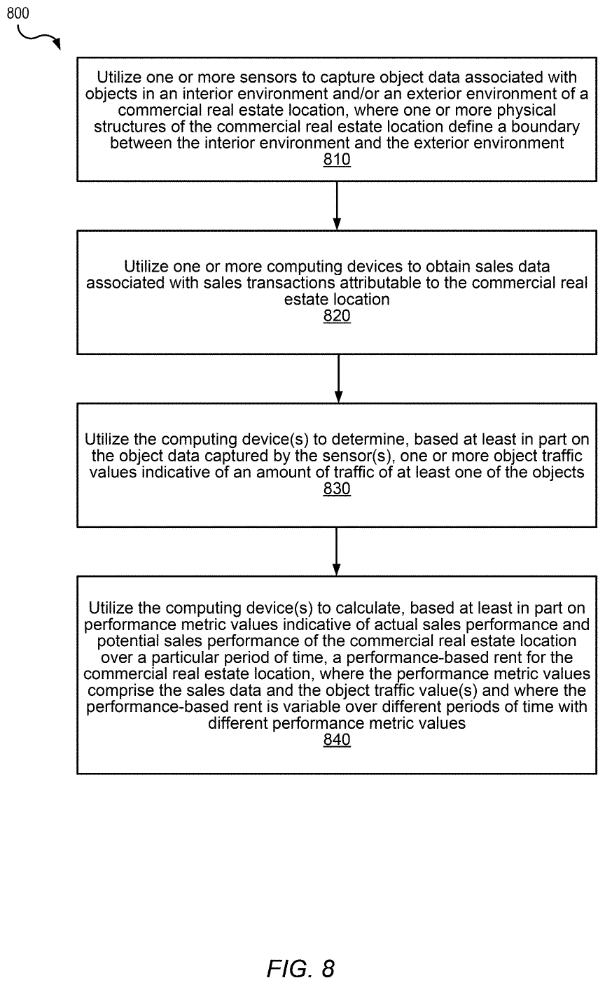

Referring to FIG. 8, a flow diagram 800 illustrates an example of a process of calculating a performance-based rent for a particular commercial real estate location that utilizes the performance-based real estate system of the present disclosure, according to some embodiments.

At operation 810, the process includes utilizing one or more sensors to capture object data associated with objects in at least one of an interior environment of a commercial real estate location or an exterior environment of the commercial real estate location. One or more physical structures of the commercial real estate location define a boundary between the interior environment and the exterior environment. For example, referring to FIG. 1, one or more physical structures of the commercial real estate location 102 may define a boundary between the interior environment 104 and the exterior environment 106. In the embodiment depicted in FIG. 1, the sensor(s) include at least the camera(s) 160 to capture object data associated with objects in the interior environment 104 of the commercial real estate location 102 and the camera(s) 170 to capture object data associated with objects in the exterior environment 106 of the commercial real estate location 102. As one example, referring to FIGS. 3A to 3C, the one or more objects may include at least the customer 302. As another example, referring to FIG. 4, the one or more objects may include at least one of the pedestrians 412-416 or the vehicles 422-426.

At operation 820, the process includes utilizing one or more computing devices to obtain sales data associated with sales transactions attributable to the commercial real estate location. For example, referring to FIG. 1, the one or more computing devices may include the POS terminal 180 for obtaining the sales data 182. To illustrate, referring to FIG. 3B, the AI micro-computer 120 may receive the sales data 182 from the POS terminal 180 as part of the sale of the merchandise 340 to the customer 302 at the commercial real estate location 102.

At operation 830, the process includes utilizing the computing device(s) to determine, based at least in part on the object data captured by the sensor(s), one or more object traffic values indicative of an amount of traffic of at least one of the objects. For example, referring to FIG. 1, the AI micro-computer 120 may determine one or more object traffic values. In a particular embodiment, the AI micro-computer 120 may be configured to perform object detection, object classification, and object tracking to determine the object traffic value(s). As one example, referring to FIGS. 3A to 3C, the one or more object traffic values may include at least the real-time customer data 310. As another example, referring to FIG. 4, the one or more object traffic values may include at least one of the real-time pedestrian data 410 and the real-time vehicle data 420.

At operation 840, the process includes utilizing the computing device(s) to calculate, based at least in part on performance metric values indicative of actual sales performance and potential sales performance of the commercial real estate location over a particular period of time, a performance-based rent for the commercial real estate location. The performance metric values comprise the sales data and the object traffic value(s), and the performance-based rent is variable over different periods of time with different performance metric values. For example, referring to FIG. 1, the AI micro-computer 120 may calculate the performance-based rent. To illustrate, referring to FIG. 7, the performance-based rent may correspond to the monthly costs 760 depicted in the performance interface 702. In a particular embodiment, the AI micro-computer 120 may be configured to: calculate first performance metric values for a first time period (e.g., a particular month); calculate second performance metric values for a second time period (e.g., a different month); and change the performance-based rent based at least in part on a difference between the first performance metric values and the second performance metric values.

While not shown in the example depicted in FIG. 8, the process may utilize feedback loops from data and AI learning, according to some embodiments. For example, various algorithms may be utilized to harness the data to continually adjust the value of real estate (e.g., price per external pedestrian, price per vehicle, price per visitor indoors, etc.). If such data analysis indicates that a particular location is succeeding or failing, rental prices may be adjusted over time to factor in the performance of the property itself. This may also apply to merchants, with the performance-based real estate data received for a particular merchant being used to recommend other locations that fit a similar pattern or recommended locations that may be a better match for their business than the location that the merchant is currently utilizing. The performance-based real estate solutions of the present disclosure may be able to automatically suggest and recommend where a merchant should operate based on the information collected and processed about both the location options available and the merchant's sales history. Such data feedback loops may be used to place merchants in more successful situations/locations.

Thus, FIG. 8 illustrates an example of a process of process of calculating a performance-based rent for a particular commercial real estate location that utilizes the performance-based real estate system of the present disclosure.

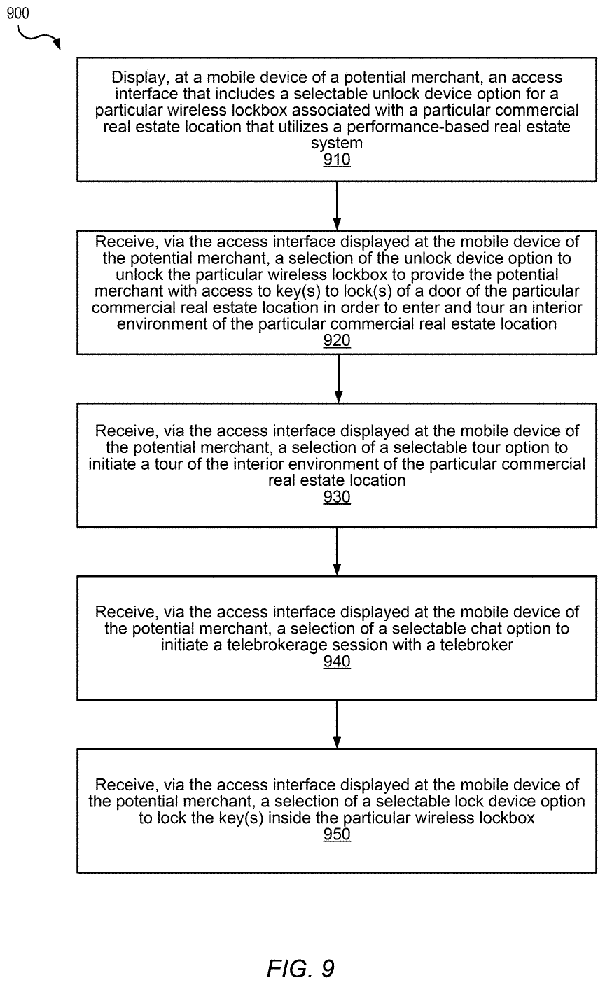

Referring to FIG. 9, a flow diagram 900 illustrates an example of a process of utilizing the performance-based real estate system of the present disclosure to enable a merchant to access and tour a commercial real estate location, according to some embodiments.

At operation 910, the process includes displaying an access interface at a mobile device of a potential merchant. The access interface includes a selectable unlock device option for a particular wireless lockbox associated with a particular commercial real estate location that utilizes a performance-based real estate system. For example, referring to FIG. 2A, the access interface 210 may be displayed at the mobile device 204 when the potential merchant 202 is located in the exterior environment 106 of the commercial real estate location 102 that utilizes the performance-based real estate system of the present disclosure. FIG. 2A illustrates a first stage of access and touring operations in which the key(s) 116 remain locked in the wireless lockbox 114, and the access interface 210 displayed at the mobile device 204 includes a selectable unlock device option 212 for unlocking the wireless lockbox 114 at the commercial real estate location 102.

At operation 920, the process includes receiving, via the access interface displayed at the mobile device of the potential merchant, a selection of the unlock device option to unlock the particular wireless lockbox to provide the potential merchant with access to key(s) to lock(s) of a door of the particular commercial real estate location in order to enter and tour an interior environment of the particular commercial real estate location. For example, referring to FIG. 2A, the mobile device 204 of the potential merchant 202 may include a touchscreen, and the merchant 202 may provide the touchscreen input 214 to select the unlock device option 212 via the access interface 210. In FIG. 2A, the merchant 202 is located in the exterior environment 106 of the commercial real estate location 102 and, prior to selection of the unlock device option 212 of the access interface 210, the key(s) 116 remain locked in the wireless lockbox 114. While not shown in FIG. 2A, upon selection of the unlock device option 212, the mobile device 204 may generate the first wireless signal (e.g., a first Bluetooth® signal, among other possibilities) to trigger the wireless lockbox 114 to enable the merchant 202 to gain access to the key(s) 116 in order to unlock the lock(s) 112 of the door 110 of the commercial real estate location 102. FIG. 2B illustrates that, after unlocking wireless lockbox 114 to gain access to the key(s) 116 and unlocking the lock(s) 112 of the door 110, the merchant 202 is able to enter and tour the interior environment 104 of the commercial real estate location 102.

At operation 930, in some embodiments, the process may include receiving, via the access interface displayed at the mobile device of the potential merchant, a selection of a selectable tour option to initiate a tour of the interior environment of the particular commercial real estate location. For example, referring to FIG. 2B in which the potential merchant 202 is located in the interior environment 104, the access interface 210 displayed at the mobile device 204 includes the selectable tour option 232. FIG. 2B illustrates an example in which the potential merchant 202 provides the second touchscreen input 234 to select the tour option 232 via the access interface 210 in order to initiate a tour of the interior environment 104 of the commercial real estate location 102. In some embodiments, the tour may include audio and/or video output via the mobile device 204 that may provide additional information to the potential merchant 202 regarding the commercial real estate location 102, such as a self-guided tour through the interior environment 104 of the commercial real estate location 102.

At operation 940, in some embodiments, the process may include receiving, via the access interface displayed at the mobile device of the potential merchant, a selection of a selectable chat option to initiate a telebrokerage session with a telebroker. For example, referring to FIG. 2B in which the potential merchant 202 is located in the interior environment 104, the access interface 210 displayed at the mobile device 204 includes the selectable chat option 233. Selection of the selectable chat option 233 by the potential merchant 202 (e.g., via a touchscreen input, not shown in FIG. 2B) may initiate a telebrokerage session with a telebroker. The telebrokerage session may be a video chat service with a cloud-based broker that utilizes a computing device at another location to provide information to the potential merchant 202 without being physically present at the commercial real estate location 102 at the same time as the potential merchant 202.

At operation 950, the process includes receiving, via the access interface displayed at the mobile device of the potential merchant, a selection of a selectable lock device option to lock the key(s) inside the particular wireless lockbox. For example, referring to FIG. 2C, the potential merchant 202 may place the key(s) 116 back inside the wireless lockbox 114, and the access interface 210 may be displayed at the mobile device 204 when the potential merchant 202 is located in the exterior environment 106 of the commercial real estate location 102. FIG. 2C illustrates that the access interface 210 displayed at the mobile device 204 includes a selectable lock device option 252 for locking the wireless lockbox 114 at the commercial real estate location 102. FIG. 2C illustrates that the merchant 202 may provide the touchscreen input 254 to select the lock device option 252 via the access interface 210. While not shown in FIG. 2C, upon selection of the lock device option 252, the mobile device 204 may generate the second wireless signal (e.g., a second Bluetooth® signal, among other possibilities) to trigger the wireless lockbox 114 to lock in order to re-secure the commercial real estate location 102.

Thus, FIG. 9 illustrates an example of a process of enabling a potential merchant to access and tour a particular commercial real estate location that utilizes the performance-based real estate system of the present disclosure. By utilizing a combination of a wireless lockbox and an access interface presented via a mobile device of the potential merchant, the performance-based real estate system of the present disclosure provides advantages to both commercial real estate owners and potential merchants by enabling secure access and touring without the involvement of a commercial real estate broker.

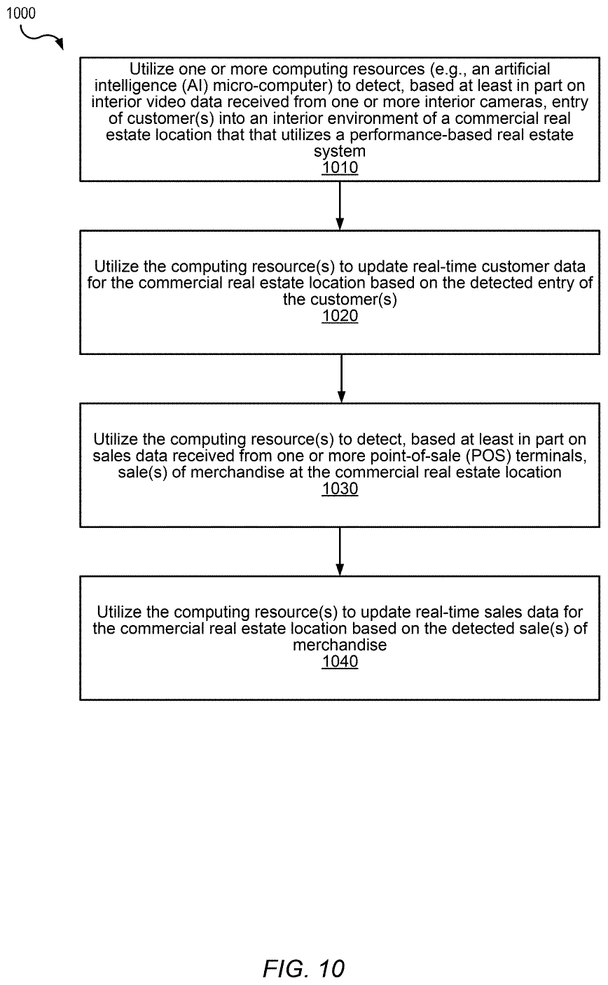

Referring to FIG. 10, a flow diagram 1000 illustrates an example of a process of real-time collection of customer and sales data at a commercial real estate location using the performance-based real estate system of the present disclosure, according to some embodiments.

At operation 1010, the process includes utilizing one or more computing resources (e.g., an AI micro-computer) to detect, based at least in part on interior video data received from interior camera(s), entry of customer(s) into an interior environment of a commercial real estate location that utilizes the performance-based real estate system of the present disclosure. For example, referring to FIG. 3A, the AI micro-computer 120 may detect the entry of the customer 302 into the interior environment 104 of the commercial real estate location 102 based on the interior video data 162 received from the interior camera(s) 160 or based on a combination of the interior video data 162 and the exterior video data 172 received from the exterior camera(s) 170.

At operation 1020, the process includes utilizing the computing resource(s) to update real-time customer data for the commercial real estate location based on the detected entry of the customer(s). For example, referring to FIG. 3A, the AI micro-computer 120 may update the real-time customer data 310 based on the detected entry of the customer 302 at the commercial real estate location 102.

At operation 1030, the process includes utilizing the computing resource(s) to detect, based at least in part on sales data received from POS terminal(s), sale(s) of merchandise at the commercial real estate location. For example, referring to FIG. 3B, the AI micro-computer 120 may detect, based at least in part on the sales data 182 received from the POS terminal(s) 180, the sale of the merchandise 340 at the commercial real estate location 102.

At operation 1040, the process includes utilizing the computing resource(s) to update real-time sales data for the commercial real estate location based on the detected sale(s) of merchandise. For example, referring to FIG. 3B, the AI micro-computer 120 may update the real-time sales data 320 based on the sales data 182 associated with the merchandise 340 that is received from the POS terminal(s) 180.

Thus, FIG. 10 illustrates an example of a process of utilizing the performance-based real estate system of the present disclosure for real-time collection of customer and sales data at a commercial real estate location.

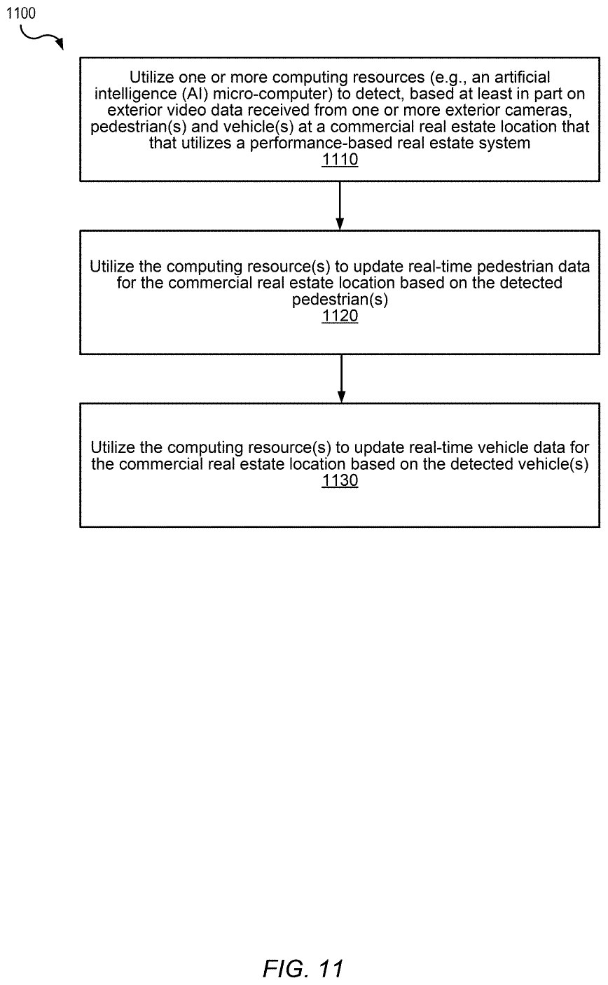

Referring to FIG. 11, a flow diagram 1100 illustrates an example an example of a process of real-time collection of pedestrian and vehicle data at a commercial real estate location using the performance-based real estate system of the present disclosure, according to some embodiments.

At operation 1110, the process includes utilizing one or more computing resources (e.g., an AI micro-computer) to detect, based at least in part on exterior video data received from exterior camera(s), pedestrian(s) and vehicle(s) at a commercial real estate location that utilizes the performance-based real estate system of the present disclosure. For example, referring to FIG. 4, the AI micro-computer 120 may detect the pedestrians 412, 414, 416 based at least in part on the exterior video data 172 received from the exterior camera(s) 170 at the commercial real estate location 102.

At operation 1120, the process includes utilizing the computing resource(s) to update real-time pedestrian data for the commercial real estate location based on the detected pedestrian(s). For example, referring to FIG. 4, the AI micro-computer may update the real-time pedestrian data 410 based on the detected pedestrians 412, 414, 416 at the commercial real estate location 102.

At operation 1130, the process includes utilizing the computing resource(s) to update real-time vehicle data for the commercial real estate location based on the detected vehicle(s). For example, referring to FIG. 4, the AI micro-computer may update the real-time vehicle data 420 based on the detected vehicles 422, 424, 426 at the commercial real estate location 102.

Thus, FIG. 11 illustrates an example of a process of utilizing the performance-based real estate system of the present disclosure for real-time collection of pedestrian and vehicle data at a commercial real estate location.

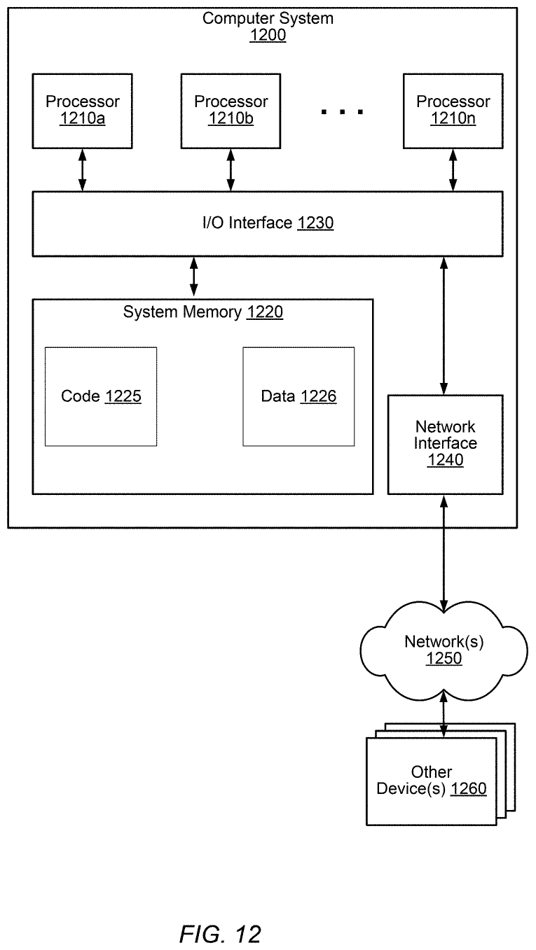

FIG. 12 is a block diagram illustrating an example computer system 1200 that is used to implement one or more portions of a performance-based real estate system, according to some embodiments. For example, the computer system 1200 may be a computer that implements one or more components of the computing resource(s) described herein (e.g., the AI micro-computer 120).

Computer system 1200 may be implemented using a variety of computing devices, such as a personal computer system, desktop computer, laptop or notebook computer, mainframe computer system, handheld computer, workstation, network computer, a consumer device, application server, mobile telephone, or some other type of computing device.

As shown, computer system 1200 includes one or more processors 1210, which may include multiple cores coupled to a system memory 1220 via an input/output (I/O) interface 1230. Computer system 1200 further includes a network interface 1240 coupled to I/O interface 1230. In some embodiments, computer system 1200 may be a uniprocessor system including one processor 1210, or a multiprocessor system including several processors 1210a-n, as shown. The processors 1210 may be any suitable processors capable of executing instructions. For example, in various embodiments, processors 1210 may implement one of a number of instruction set architectures (ISAs), such as the x86, PowerPC, SPARC, or MIPS ISA.

As shown, the computer system 1200 may also include one or more network communication devices (e.g., network interface 1240) for communicating with other systems and/or components over a communications network. For example, an instance of an application executing on computer system 1200 may use network interface 1240 to communicate with another server application executing on another computer system, as described herein.

As shown, computer system 1200 may use its network interface 1240 to communicate with one or more other devices 1260, such as persistent storage devices and/or one or more I/O devices. In some embodiments, some of these other devices may be implemented locally on the computer system 1200, accessible via the I/O interface 1230. In various embodiments, persistent storage devices may include disk drives, tape drives, solid state memory, other mass storage devices, or any other persistent storage device. The computer system 1200 may store instructions and/or data in persistent storage devices, and retrieve the stored instruction and/or data as needed.

As shown, the computer system 1200 may include one or more system memories 1220 that store instructions and data accessible by processor(s) 1210. In various embodiments, system memories 1220 may be implemented using any suitable memory technology, (e.g., one or more of cache, static random-access memory (SRAM), DRAM, RDRAM, EDO RAM, DDR 10 RAM, synchronous dynamic RAM (SDRAM), EEPROM, non-volatile/Flash-type memory, etc.). The system memory 1220 may be used to store code 1225 or executable instructions to implement the methods and techniques described herein. For example, the executable instructions may include instructions to implement the customer, sales, pedestrian, and vehicle detection and instructions to implement the real-time customer, sales, pedestrian, and vehicle data updates, as discussed. The system memory 1220 may also be used to store data 1226 needed or produced by the executable instructions. For example, the in-memory data 1226 may include portions of the customer data, sales data, pedestrian data, and vehicle data, as discussed.

In some embodiments, some of the code 1225 or executable instructions may be persistently stored on the computer system 1200 and may have been loaded from external storage media. The persistent storage of the computer system 1200 and the external media are examples of non-transitory computer-readable storage media, which may be used to store program instructions to be executed by the computer system 1200. A non-transitory computer-readable storage medium may provide the capability to store information in a form readable by a machine (e.g., computer system 1200). Non-transitory computer-readable media may include storage media such as magnetic or optical media, disk or DVD/CD-ROM devices, archival tapes, network-attached storage systems, or other computer systems.

In some embodiments, the I/O interface 1230 may be configured to coordinate I/O traffic between processor 1210, system memory 1220 and any peripheral devices in the system, including through network interface 1240 or other peripheral interfaces. In some embodiments, I/O interface 1230 may perform any necessary protocol, timing or other data transformations to convert data signals from one component (e.g., system memory 1220) into a format suitable for use by another component (e.g., processor 1210). In some embodiments, I/O interface 1230 may include support for devices attached through various types of peripheral buses, such as a variant of the Peripheral Component Interconnect (PCI) bus standard or the Universal Serial Bus (USB) standard, for example. In some embodiments, the function of I/O interface 1230 may be split into two or more separate components, such as a north bridge and a south bridge, for example. Also, in some embodiments, some or all of the functionality of I/O interface 1230, such as an interface to system memory 1220, may be incorporated directly into processor 1210.

In some embodiments, the network interface 1240 may allow data to be exchanged between computer system 1200 and other devices attached to a network. The network interface 1240 may also allow communication between computer system 1200 and various I/O devices and/or remote storage systems. Input/output devices may, in some embodiments, include one or more display terminals, keyboards, keypads, touchpads, scanning devices, voice or optical recognition devices, or any other devices suitable for entering or retrieving data by one or more computer systems. Multiple input/output devices may be present in computer system 1200 or may be distributed on various nodes of a distributed system that includes computer system 1200. In some embodiments, similar input/output devices may be separate from computer system 1200 and may interact with one or more nodes of a distributed system that includes computer system 1200 through a wired or wireless connection, such as over network interface 1240. Network interface 1240 may commonly support one or more wireless networking protocols (e.g., Wi-Fi/IEEE 802.11, or another wireless networking standard). In some embodiments, the network interface 1240 may support communication via telecommunications/telephony networks such as analog voice networks or digital fiber communications networks, via storage area networks such as Fibre Channel SANs, or via any other suitable type of network and/or protocol.

Various modifications and changes may be made as would be obvious to a person skilled in the art having the benefit of this disclosure. The various embodiments described herein are meant to be illustrative and not limiting. Many variations, modifications, additions, and improvements are possible. These and other variations, modifications, additions, and improvements may fall within the scope of embodiments as defined in the claims that follow.

What is claimed is:

1. A system, comprising:
one or more sensors configured to capture object data associated with objects in at least one of an interior environment of a commercial real estate location or an exterior environment of the commercial real estate location, wherein one or more physical structures of the commercial real estate location define a boundary between the interior environment and the exterior environment; and
one or more computing devices configured to:
obtain sales data associated with sales transactions attributable to the commercial real estate location;
determine, based at least in part on the object data captured by the one or more sensors, one or more object traffic values indicative of an amount of traffic of at least one of the objects; and
calculate, based at least in part on performance metric values indicative of actual sales performance and potential sales performance of the commercial real estate location over a particular period of time, a performance-based rent for the commercial real estate location, wherein the performance metric values comprise the sales data and the one or more object traffic values, and wherein the performance-based rent is variable over different periods of time with different performance metric values.

2. The system of claim 1, wherein the one or more objects comprise at least one of a pedestrian, a customer, or a vehicle.

3. The system of claim 1, wherein the one or more sensors comprise a camera.

4. The system of claim 1, wherein the one or more computing devices comprise a point-of-sale (POS) terminal for obtaining the sales data.

5. The system of claim 1, wherein the one or more computing devices comprise an artificial intelligence (AI) micro-computer configured to determine the one or more object traffic values.

6. The system of claim 5, wherein the AI micro-computer is configured to perform at least one of object detection, object classification, or object tracking to determine the one or more object traffic values.

7. The system of claim 1, wherein the one or more computing device comprise an artificial intelligence (AI) micro-computer configured to calculate the performance-based rent.

8. The system of claim 7, wherein the AI micro-computer is configured to:
calculate first performance metric values for a first time period;
calculate second performance metric values for a second time period; and
change the performance-based rent based at least in part on a difference between the first performance metric values and the second performance metric values.

9. The system of claim 1, wherein the one or more computing devices are configured to generate a user interface that presents at least the performance-based rent for the commercial real estate location and at least a portion of the performance metric values.

10. A method comprising:
implementing, using one or more sensors, one or more object data capture operations, wherein the implementing comprises capturing object data associated with objects in at least one of an interior environment of a commercial real estate location or an exterior environment of the commercial real estate location, wherein one or more physical structures of the commercial real estate location define a boundary between the interior environment and the exterior environment; and
implementing, using one or more computing devices, one or more performance-based rent calculations, wherein the implementing comprises:
obtaining sales data associated with sales transactions attributable to the commercial real estate location;
determining, based at least in part on the object data captured by the one or more sensors, one or more object traffic values indicative of an amount of traffic of at least one of the objects; and
calculating, based at least in part on performance metric values indicative of actual sales performance and potential sales performance of the commercial real estate location over a particular period of time, a performance-based rent for the commercial real estate location, wherein the performance metric values comprise the sales data and the one or more object traffic values, and wherein the performance-based rent is variable over different periods of time with different performance metric values.

11. The method of claim 10, wherein the one or more objects comprise at least one of a pedestrian, a customer, or a vehicle.

12. The method of claim 10, wherein the one or more sensors comprise one or more cameras located in the interior environment of the commercial real estate location, and wherein the one or more objects include at least a customer.

13. The method of claim 10, wherein the one or more sensors comprise one or more cameras located in the exterior environment of the commercial real estate location, and wherein the one or more objects include at least a pedestrian or a vehicle.

14. The method of claim 10, wherein the one or more computing devices comprise an artificial intelligence (AI) micro-computer configured to:
perform at least one of object detection, object classification, or object tracking to determine the one or more object traffic values; and
calculate the performance-based rent.

15. The method of claim 14, wherein the AI micro-computer is configured to:
calculate first performance metric values for a first time period;
calculate second performance metric values for a second time period; and
change the performance-based rent based at least in part on a difference between the first performance metric values and the second performance metric values.

16. One or more non-transitory computer-accessible storage media storing program instructions that, when executed on or across one or more computing devices, implement at least a portion of a system that implements one or more performance-based rent calculations and cause the system to:
receive, from one or more sensors configured to capture object data associated with objects in at least one of an interior environment of a commercial real estate location or an exterior environment of the commercial real estate location, wherein one or more physical structures of the commercial real estate location define a boundary between the interior environment and the exterior environment;
obtain sales data associated with sales transactions attributable to the commercial real estate location;
determine, based at least in part on the object data captured by the one or more sensors, one or more object traffic values indicative of an amount of traffic of at least one of the objects; and
calculate, based at least in part on performance metric values indicative of actual sales performance and potential sales performance of the commercial real estate location over a particular period of time, a performance-based rent for the commercial real estate location, wherein the performance metric values comprise the sales data and the one or more object traffic values, and wherein the performance-based rent is variable over different periods of time with different performance metric values.

17. The one or more non-transitory computer-accessible storage media of claim 16, wherein the one or more objects comprise at least one of a pedestrian, a customer, or a vehicle.

18. The one or more non-transitory computer-accessible storage media of claim 16, wherein:
the one or more sensors comprise one or more cameras located in the interior environment of the commercial real estate location and one or more cameras located in the exterior environment of the commercial real estate location; and
the one or more objects comprise at least one of a pedestrian, a customer, or a vehicle.

19. The one or more non-transitory computer-accessible storage media of claim 16, wherein the one or more computing devices comprise an artificial intelligence (AI) micro-computer configured to:
perform at least one of object detection, object classification, or object tracking to determine the one or more object traffic values; and
calculate the performance-based rent.

20. The one or more non-transitory computer-accessible storage media of claim 19, wherein the AI micro-computer is configured to:
calculate first performance metric values for a first time period;
calculate second performance metric values for a second time period; and
change the performance-based rent based at least in part on a difference between the first performance metric values and the second performance metric values.
